(19) United States
(12) Patent Application Publication
(10) Pub. No.: US 2026/0237533 A1
(43) Pub. Date: Aug. 13, 2026

(54) METHOD FOR STABILIZING AND IMMOBILIZING URANIUM AT SOURCE VIA FORMATION OF MINERAL FILM MEDIATED BY MICROORGANISMS

(71) Applicant: UNIVERSITY OF SOUTH CHINA, Hengyang City (CN)

(72) Inventors: Qian LI, Hengyang City (CN); Jing SUN, Hengyang City (CN); Shangze LI, Hengyang City (CN); Ling XIAO, Hengyang City (CN); Guangyue LI, Hengyang City (CN); Zhao CUI, Hengyang City (CN); Ting LI, Hengyang City (CN)

(21) Appl. No.: 19/535,429

(22) Filed: Feb. 10, 2026

(30) Foreign Application Priority Data
Feb. 11, 2025 (CN) 202510147067.6

(51) Int. Cl. G21F 9/30; B09C 1/02; B09C 1/08; B09C 1/10

(52) U.S. Cl. CPC G21F 9/305; B09C 1/02; B09C 1/08; B09C 1/10

(57) ABSTRACT

Provided is a method for stabilizing and immobilizing uranium at source via formation of a mineral film mediated by microorganisms. The method includes the following step: forming the mineral film on a surface of a uranium-containing waste through mediation by acidophilic iron-oxidizing microorganisms using an additional ferrous source.

### CROSS REFERENCE TO RELATED APPLICATION

This patent application claims the benefit and priority of Chinese Patent Application No. 202510147067.6 filed with the China National Intellectual Property Administration on Feb. 11, 2025, the disclosure of which is incorporated by reference herein in its entirety as part of the present application.

### TECHNICAL FIELD

The present disclosure belongs to the technical field of heavy metal treatment, and in particular relates to a method for stabilizing and immobilizing uranium at source via formation of a mineral film mediated by microorganisms.

### BACKGROUND

Uranium tailings residue/uranium tailings sand are wastes generated during the processing of uranium ore resources after crushing, grinding and extracting useful components. Uranium tailings residue/uranium tailings sand are industrial residues that are inevitably produced during uranium ore mining and smelting, and are a long-lived, largely low-radioactive solid waste. The grade of uranium ore in China is generally low, so a large number of uranium tailings residue/uranium tailings sand are produced. Such uranium tailings sand are mainly stored and disposed by constructing tailings impoundments on the surface. Under the long-term weathering and leaching, the radioactive nuclides or heavy metals contained in such uranium tailings sand migrate and diffuse, causing pollution to the soil, water, and air. In particular, most of such uranium tailings sand are acidic, and the acid or acid ions remaining in the tailings or residue accelerate the dissolution of residual uranium from the ore, seriously polluting the surrounding water and soil environment.

In the prior art, uranium-containing waste can be treated by microbial reduction and immobilization, but a resulting reduced tetravalent uranium compounds have too small crystal grains and can migrate together with colloids in water. If the plant-microorganism combined remediation technology is adopted, the biggest challenge is that the selection of hyperaccumulating plants is difficult. The hyperaccumulating plants usually grow slowly, and many factors affect the remediation efficiency, including soil physical and chemical properties, uranium occurrence forms, chelating agents added, rhizosphere microbial community structure and activity, etc., which can not achieve a stabilizing and immobilizing effect. If the microbial grouting solidification technology is adopted, it is difficult to penetrate into the small pores, so that the uranium in the surrounding particles is still in an unstable state, and most of the immobilized uranium does not enter the stable mineral lattice, and it is easy to be oxidized and dissolved and gradually migrate, becoming a potential uranium pollution source in the surrounding environment. In summary, current methods for treating uranium-containing waste can not achieve a stabilizing and immobilizing effect. After treatment, the uranium remains in an unstable state, which then pollutes the surrounding environment over time.

In view of this, it is necessary to design a method that can stabilize and immobilize uranium from the source to treat uranium-containing waste.

### SUMMARY

The present disclosure is to provide a method for stabilizing and immobilizing uranium at source via formation of a mineral film mediated by microorganisms. The method can effectively inhibit the migration and release of radioactive metal element uranium and the acidification phenomenon in uranium-containing waste and reduce the risk of uranium release from the source.

The present disclosure provides the following technical solutions.

Provided is a method for stabilizing and immobilizing uranium at source via formation of a mineral film mediated by microorganisms, including the following step:
forming the mineral film on a surface of a uranium-containing waste through mediation by acidophilic iron-oxidizing microorganisms using an additional ferrous source.

In some embodiments, the acidophilic iron-oxidizing microorganisms are at least one selected from the group consisting of Acidithiobacillus ferrooxidans (A. ferrooxidans), Leptospirillum ferriphilum (L. ferriphilum), Leptospirillum ferrooxidans (L. ferrooxidans), and Sulfobacillus thermosulfidooxidans (S. thermosulfidooxidans).

In some embodiments, the uranium-containing waste includes at least one selected from the group consisting of uranium tailings residue, uranium tailings sand, and uranium-containing waste stone.

In some embodiments, the additional ferrous source is at least one selected from the group consisting of ferrous sulfate and pyrite.

In some embodiments, forming the mineral film on the surface of the uranium-containing waste through the mediation by the acidophilic iron-oxidizing microorganisms using the additional ferrous source includes:
crushing and sieving the uranium-containing waste to obtain uranium-containing particles or powders;
inoculating a bacterial cell suspension of the acidophilic iron-oxidizing microorganisms into a ferrous-containing culture medium and culturing, to obtain the culture;
inoculating the culture into the additional ferrous source to obtain a passivation solution; and
passivating the uranium-containing particles or powders by using the passivation solution to form the mineral film on the surface of the uranium-containing waste particles or powders.

In some embodiments, the uranium-containing particles or powders each have a particle size of not greater than 5 mm.

In some embodiments, the passivating is conducted in a stirred reactor or a column percolation reactor; the passivation solution has an initial pH value of 1.5 to 5, and the passivating is conducted at a temperature of 25° C. to 45° C.

In some embodiments, under a condition that the passivating is conducted in the stirred reactor, a solid-liquid ratio of the passivating is less than 15% (which means that a mass of a solid is less than 15% of a mass of a liquid) and the passivating is conducted for not less than 6 h; and under a condition that the passivating is conducted in the column percolation reactor, the solid-liquid ratio of the passivating is less than 3:1 and the passivating is conducted for not less than 10 days.

In some embodiments, the passivation solution further includes an additional cation;
the additional cation is at least one selected from the group consisting of potassium ions, sodium ions, and ammonium ions; and
an ionic molar ratio of the additional ferrous source to the additional cation is in a range of 3:0.5 to 3:2.

The present disclosure further provides a passivation solution, including acidophilic iron-oxidizing microorganisms and an additional ferrous source.

### Beneficial Effects

The present disclosure provides a method for stabilizing and immobilizing uranium at source via formation of a mineral film mediated by microorganisms. According to the present disclosure, the mineral film is formed on a surface of a uranium-containing waste through mediation by acidophilic iron-oxidizing microorganisms using an additional ferrous source (components of the mineral film include at least one selected from the group consisting of jarosite, goethite, magnetite, gypsum, diaspore, and kaolinite), thereby reducing the diffusion of radioactive elements in uranium-containing waste. In the present disclosure, Fe (II) in uranium-containing waste or Fe²⁺ in solution is oxidized by acidophilic iron-oxidizing microorganisms, and Fe³⁺ and “labile uranium” in uranium tailings sand are released at the same time, while Fe³⁺ hydrolyzes, precipitates, and covers the surface of uranium-containing waste to form a layer of iron film (Fe₂O₃ or Fe(OH)₃ or goethite). Furthermore, the phosphorus source in the ore transforms UO₂²⁺ to uranyl phosphate, which can form a stable ternary complex with the iron film on the ore surface and crystallize and deposit on the surface of the waste. Subsequently, the dissolved Ca²⁺ and Al³⁺ are hydrolyzed to form insoluble sulfate or hydroxide precipitate, or are transformed to corresponding secondary minerals, which in turn coat the uranyl phosphate ternary complex formed on the surface of the previous waste to form a mineral film. Further, in the present disclosure, cations (one or more of potassium ions, sodium ions or ammonium ions) are added when passivating the uranium-containing waste, and the remaining Fe³⁺ in the system can form a dense jarosite film to further coat the uranium-containing waste in the presence of cations such as SO₄²⁻ and K⁺, Na⁺ or NH⁴⁺ so as to form a multi-layer stable mineral film, and achieve the purpose of immobilizing the uranium-containing waste and stabilizing the radioactive element uranium contained therein for a long time.

In the present disclosure, the method can effectively inhibit the migration and release of radioactive metal element uranium and the acidification phenomenon in uranium-containing waste and reduce the risk of uranium release from the source. Furthermore, the method can overcome the shortcomings of existing passivation methods, reduce the amount of conventional passivation agents used, lower costs, and avoid secondary pollution and eutrophication of water bodies, which is of great significance to enriching the theoretical system of environmental restoration in uranium mines and promoting the sustainable development of the uranium mining and metallurgical industry.

### BRIEF DESCRIPTION OF THE DRAWINGS

To more clearly illustrate the technical solutions in the embodiments of the present disclosure or in the prior art, the accompanying drawings required for the embodiments will be briefly described below.

FIG. 1 shows a scanning electron microscope image of the sample with a particle size of less than 0.074 mm in Example 1 after biological passivation for 138 h;

FIG. 2 shows a scanning electron microscope image of the sample with a particle size of 0.074 mm to 0.1 mm in Example 1 after biological passivation for 138 h;

FIG. 3 shows a graph of leached uranium concentration of samples with different particle sizes after biological passivation for 138 h;

FIG. 4 shows a graph of leached uranium concentration after biological passivation for 138 h under different initial pH values of passivation solution;

FIG. 5 shows a graph of leached uranium concentration after biological passivation for 138 h under different temperatures;

FIG. 6 shows a graph of leached uranium concentration after biological passivation for 138 h under different solid-liquid ratios (ratio of sample to passivation solution);

FIG. 7A shows the scanning electron microscope image of the raw sample in Comparative Example 1 (sample with a particle size of less than 0.074 mm), and FIG. 7B shows the scanning electron microscope image of the sample in Example 1 after passivation for 138 h; and

FIG. 8A shows the pH change graph of Example 1 (sample with a particle size of less than 0.074 mm) and Comparative Example 1, and FIG. 8B shows the leached uranium graph of Example 1 (sample with a particle size of less than 0.074 mm) and Comparative Example 1.

### DETAILED DESCRIPTION OF THE EMBODIMENTS

The present disclosure provides a method for stabilizing and immobilizing uranium element at source via formation of a mineral film mediated by microorganisms, including the following step:
forming the mineral film on a surface of a uranium-containing waste through mediation by acidophilic iron-oxidizing microorganisms using an additional ferrous source.

In some embodiments of the present disclosure, the acidophilic iron-oxidizing microorganisms are at least one selected from the group consisting of Acidithiobacillus ferrooxidans, Leptospirillum ferriphilum, Leptospirillum ferrooxidans, and Sulfobacillus thermosulfidooxidans.

In the present disclosure, there is no special limitation on the source of the acidophilic iron-oxidizing microorganisms, which can be commercially available or can be extracted from acidic mine water and soil near coal mines by using methods well known to those skilled in the art. In the specific embodiment of the present disclosure, source of the acidophilic iron-oxidizing microorganisms is shown in Table 1.

TABLE 1
Source of acidophilic iron-oxidizing microorganisms

| Strain | Source | Culture medium | Temperature | pH |
|---|---|---|---|---|
| Acidithiobacillus | American Type Culture | 9K + FeSO₄•7H₂O (44.7 | 30° C. | 2.0 |
| ferrooxidans ATCC 23270 | Collection | g/L) | | |
| Leptospirillum ferriphilum | Acidic mine water | 9K + FeSO₄•7H₂O (44.7 | 40° C. | 1.5 |
| YSK | from Jiangxi Dexing | g/L) | | |
| | Copper Mine, China | | | |
| Sulfobacillus | Acidic hot springs | 9K + yeast powder (0.2 | 45° C. | 1.5 |
| thermosulfidooxidans ST | from Tengchong, | g/L) + FeSO₄•7H₂O (44.7 | | |
| | Yunnan, China | g/L) | | |

In some embodiments of the present disclosure, the uranium-containing waste includes at least one selected from the group consisting of uranium tailings residue, uranium tailings sand, and uranium-containing waste stone. The uranium tailings residue is specifically tailings residue produced after uranium ore is leached through surface heap leaching or in-situ blasting.

In some embodiments of the present disclosure, the additional ferrous source is at least one selected from the group consisting of ferrous sulfate and pyrite.

In some embodiments of the present disclosure, forming the mineral film on the surface of the uranium-containing waste through the mediation by the acidophilic iron-oxidizing microorganisms using the additional ferrous source includes:
crushing and sieving the uranium-containing waste to obtain uranium-containing particles or powders;
inoculating a bacterial cell suspension of the acidophilic iron-oxidizing microorganisms into a ferrous-containing culture medium and culturing, to obtain a culture;
inoculating the culture into an additional ferrous source to obtain a passivation solution; and
passivating the uranium-containing particles or powders by using the passivation solution to form the mineral film on the surface of the uranium-containing waste particles or powders.

In the present disclosure, the uranium-containing waste is crushed and sieved to obtain uranium-containing particles or powders. In some embodiments of the present disclosure, the uranium-containing particles or powders each have a particle size of less than 5 mm, specifically less than 0.074 mm, 0.074 mm to 0.1 mm, less than 2 mm, 0.3 mm to 0.9 mm, 2 mm to 0.9 mm or 2 mm to 3 mm.

In the present disclosure, a bacterial cell suspension of the acidophilic iron-oxidizing microorganisms are inoculated into a ferrous-containing culture medium and subjected to culturing, to obtain a culture. In some embodiments of the present disclosure, the culturing includes conducting activation culture and scale-up culture in sequence. In some embodiments, an inoculation volume of the bacterial cell suspension of the acidophilic iron-oxidizing microorganisms in the activation culture is in a range of 5% to 20%, specifically is 6%, 10% or 15%. In some embodiments, a ferrous content in the ferrous-containing culture medium used for the activation culture is in a range of 5 g/L to 10 g/L, specifically is 6 g/L, 8 g/L or 9 g/L. In some embodiments, a volume of the ferrous-containing culture medium used for the activation culture is 100 mL. In some embodiments, the activation culture is conducted in a shaker. In some embodiments, the conditions for the activation culture include: an initial pH value of 1.5 to 3.5, specifically 2.0, 2.5, and 3.0, an initial temperature of 10° C. to 40° C., specifically 15° C., 20° C., 25° C., 30° C., 35° C. or 40° C., and a shaker speed of 100 r/min to 200 r/min, specifically 110 r/min, 150 r/min, 170 r/min or 190 r/min. In some embodiments, the method further includes, in the activation culture, counting the number of living cells using a hemocytometer every day, and when a bacterial concentration can reach 10⁸-10⁹ cells/mL, the activation culture is completed. In some embodiments, the method further includes, after the activation culture, inoculating a resulting activation cultured culture into the ferrous-containing culture medium and conducting scale-up culture, where a volume of the ferrous-containing culture medium used for the scale-up culture is 6 L. In some embodiments, the inoculation volume and culture conditions for the scale-up culture are the same as those for the activation culture, and will not be repeatedly described here. In some embodiments, the scale-up culture is conducted until the bacterial concentration can reach 10⁸-10⁹ cells/mL. In some embodiments, the method further includes, after the scale-up culture, removing a resulting filter residue, to obtain a filtrate as the culture.

In the present disclosure, after the culture is obtained, the culture is inoculated into an additional ferrous source to obtain a passivation solution. In some embodiments of the present disclosure, under a condition that the additional ferrous source is ferrous sulfate, the additional ferrous source is used in a form of an additional ferrous source solution. In some embodiments, a concentration of ferrous ions in the additional ferrous source solution is in a range of 5 g/L to 10 g/L, specifically is 6 g/L, 8 g/L or 9 g/L. In some embodiments, under a condition that the additional ferrous source is pyrite, the pyrite is ground to not greater than 200 mesh and then directly added into the culture. In some embodiments, a bacterial concentration of the culture is about 5×10⁸ cells/mL, and an inoculation volume of the culture in the passivation solution is in a range of 2% to 5%, specifically 3% or 4%. In some embodiments, the passivation solution further includes an additional cation. In some embodiments, the additional cation is at least one selected from the group consisting of potassium ions, sodium ions, and ammonium ions; and an ionic molar ratio of the additional ferrous source to the additional cation is in a range of 3:0.5 to 3:2, specifically is 3:1 or 3:1.5. In some embodiments, under a condition that the passivation solution includes the additional cation, the method further includes, mixing the additional ferrous source solution and the additional cation, and then inoculating the culture into a resulting mixture.

In the present disclosure, after the passivation solution is obtained, the uranium-containing particles or powders are subjected to passivating by using the passivation solution to form the mineral film on the surface thereof. In some embodiments of the present disclosure, the passivating is conducted in a stirred reactor or a column percolation reactor. In some embodiments, the passivation solution has an initial pH value of 1.5 to 5, specifically 2, 3 or 4, and the passivating is conducted at a temperature of 25° C. to 45° C., specifically 30° C., 35° C. or 40° C.

In some embodiments of the present disclosure, under a condition that the passivating is conducted in the stirred reactor, a solid-liquid ratio for the passivating is less than 15%, specifically 1%, 5% or 10%; and the passivating is conducted for not less than 6 h, specifically is 42 h, 60 h, 100 h or 114 h. In some embodiments, under a condition that the passivating is conducted in the column percolation reactor, a solid-liquid ratio for the passivating is less than 3:1, specifically 2:1, 1:1 or 1:2, and the passivating is conducted for not less than 10 days, specifically 30 days, 50 days, 60 days or 80 days.

The present disclosure further provides a passivation solution, including acidophilic iron-oxidizing microorganisms and an additional ferrous source, as described in the aforementioned technical solutions.

In the present disclosure, Fe (II) in uranium-containing waste or Fe²⁺ in solution is oxidized by acidophilic iron-oxidizing microorganisms, and Fe³⁺ and “labile uranium” in uranium tailings sand are released at the same time, while Fe³⁺ hydrolyzes, precipitates and covers the surface of uranium-containing waste to form a layer of iron film (Fe₂O₃ or Fe(OH)₃ or goethite). Furthermore, the phosphorus source in the ore transforms UO₂²⁺ to uranyl phosphate, which can form a stable ternary complex with the iron film on the ore surface and crystallize and deposit on the surface of the waste. Subsequently, the dissolved Ca²⁺ and Al³⁺ are hydrolyzed to form insoluble sulfate or hydroxide precipitate, or are transformed to corresponding secondary minerals, which in turn coat the uranyl phosphate ternary complex formed on the surface of the previous waste to form a mineral film. Further, in the present disclosure, cations (one or more of potassium ions, sodium ions or ammonium ions) are added when passivating the uranium-containing waste, and the remaining Fe³⁺ in the system can form a dense jarosite film to further coat the uranium-containing waste in the presence of cations such as SO₄²⁻and K⁺, Na⁺ or NH⁴⁺, so as to form a multi-layer stable mineral film, and achieve the purpose of immobilizing the uranium-containing waste and stabilizing the radioactive element uranium contained therein for a long time.

To further illustrate the present disclosure, the method for stabilizing and immobilizing uranium at source via formation of a mineral film mediated by microorganisms provided by the present disclosure will be described in detail in conjunction with the accompanying drawings and examples below, which cannot be construed as limiting the scope of the present disclosure.

### Example 1

(1) Heap leaching uranium tailings residue was crushed and sieved to obtain samples with particle sizes of less than 0.074 mm, 0.074 mm to 0.1 mm, 0.3 mm to 0.9 mm, 2 mm to 0.9 mm, and 2 mm to 3 mm, respectively.
(2) A bacterial cell suspension of Acidithiobacillus ferrooxidans was inoculated into 100 mL of 9K culture medium with 10% inoculation volume and subjected to activation culture, with an initial pH value being 2.0, a temperature being 30° C., and a shaker speed being 170 r/min. Number of living cells was counted by blood cell counting plate every day. When a bacterial concentration reached 10⁸ cells/mL, the activation culture was completed and a resulting filter residue was removed.
(3) A resulting activation cultured Acidithiobacillus ferrooxidans was inoculated into 6 L of 9K culture medium containing 9 g/L of ferrous iron with 10% inoculation volume and subjected to scale-up culture, with an initial pH value being 2, a temperature being 30° C., and a shaker speed being 170 r/min. Number of living cells was counted by blood cell counting plate every day. When a culture concentration could reach 10⁸ cells/mL, the scale-up culture was completed and a resulting filter residue was removed to obtain a concentrated culture.
(4) The concentrated culture was inoculated into 150 mL of a passivation solution consisting of 44.7 g/L of FeSO₄·7H₂O and 9K culture medium with 30 mM K⁺ concentration, and a bacterial concentration in the passivation solution was 1×10⁸ cells/mL. An initial pH of the passivation solution was adjusted to 2.0 by dropping sulfuric acid, and a resulting treated passivation solution was injected into a stirred reactor filled with 1.5 g of sample, after which the sample was passivated for 138 h under conditions of a solid-liquid ratio of 1%, a shaker speed of 170 r/min, and a temperature of 30° C.

FIG. 1 shows a scanning electron microscope image of the sample with a particle size of less than 0.074 mm in Example 1 after biological passivation for 138 h. It can be seen that there is no corrosion pit on the surface of the slag after biological passivation for 138 h, and a smooth and dense passivation “protective layer” is formed.

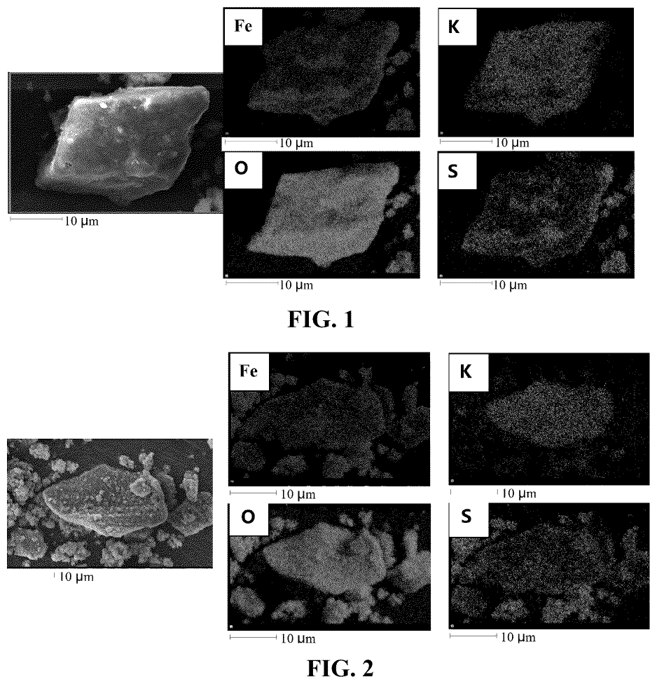

FIG. 2 shows a scanning electron microscope image of the sample with a particle size of 0.074 mm to 0.1 mm in Example 1 after biological passivation for 138 h. It can be seen that there is no corrosion pit on the surface of the slag after biological passivation for 138 h, and a “protective layer” is formed. The main constituent elements of mineral film (jarosite) are iron, potassium, oxygen, and sulfur.

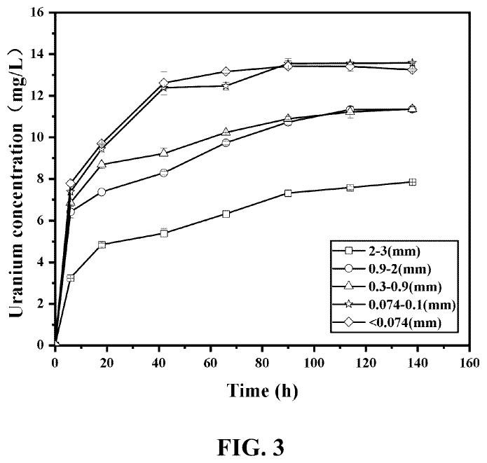

FIG. 3 shows a graph of leached uranium concentration of samples with different particle sizes after biological passivation for 138 h. The results show that uranium in powder samples with a particle size of less than 0.074 mm and powder samples with a particle size of 0.074 mm to 0.1 mm would be partially leached before 80 h (uranium concentration is about 14 mg/L, and uranium in solution can be recovered by ion exchange resin adsorption), and there is no leaching in the following time. In addition, as shown in FIG. 3, it can be seen that when the particle size of the sample is less than 0.1 mm, the mineral film can be coated in 42 h, and when the particle size of the sample is 2 mm to 3 mm, the mineral film can be coated in 90 h, which shows that the method of the present disclosure can quickly coat the slag and prevent the radioactive metal from being continuously leached, which is of great significance to the environmental management and protection of the mining area.

### Example 2

(1) Heap leaching uranium tailings residue was crushed and sieved to obtain a sample with a particle size of 0.074 mm.
(2) A bacterial cell suspension of Acidithiobacillus ferrooxidans was inoculated into 100 mL of 9K culture medium with 10% inoculation volume and subjected to activation culture, with an initial pH value being 2.0, a temperature being 30° C. and a shaker speed being 170 r/min. Number of living cells was counted by blood cell counting plate every day. When a bacterial concentration reached 10⁸ cells/mL, the activation culture was completed and a resulting filter residue was removed.
(3) A resulting activation cultured Acidithiobacillus ferrooxidans was inoculated into 6 L of 9K culture medium containing 9 g/L of ferrous iron with 10% inoculation volume and subjected to scale-up culture, with an initial pH value being 2, a temperature being 30° C., and a shaker speed being 170 r/min. Number of living cells was counted by blood cell counting plate every day. When a culture concentration could reach 10⁸ cells/mL, the scale-up culture was completed and a resulting filter residue was removed to obtain a concentrated culture.
(4) The concentrated culture was inoculated into 150 mL of passivation solution consisting of 44.7 g/L of FeSO₄·7H₂O and 9K culture medium with 30 mM K⁺ concentration, and a bacterial concentration in the passivation solution was 1×10⁸ cells/mL. An initial pH of the passivation solution was adjusted to 1.5, 2, 3, 4, 5, and 6 by dropping sulfuric acid, respectively, and a resulting treated passivation solution was injected into a stirred reactor filled with 1.5 g of sample, after which the sample was passivated for 138 h under conditions of a solid-liquid ratio of 1%, a shaker speed of 170 r/min, and a temperature of 30° C.

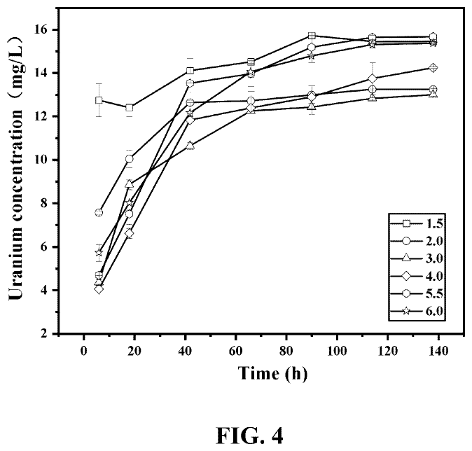

FIG. 4 shows a graph of leached uranium concentration after biological passivation for 138 h under different initial pH values of passivation solution. The results show that when the initial pH value of the passivation solution is 2, uranium in the sample is leached to some extent, but it reaches a stable point more quickly, and there is no leaching in the following time, whereas all other groups show an upward trend. It shows that the method of the present disclosure can quickly coat the slag and prevent the radioactive metal from being continuously leached, which is of great significance to the environmental management and protection of the mining area.

### Example 3

(1) Heap leaching uranium tailings residue was crushed and sieved to obtain a sample with a particle size of 0.074 mm.
(2) A bacterial cell suspension of Acidithiobacillus ferrooxidans was inoculated into 100 mL of 9K culture medium with 10% inoculation volume and subjected to activation culture, with an initial pH value being 2.0, a temperature being 30° C. and a shaker speed being 170 r/min. Number of living cells was counted by blood cell counting plate every day. When a bacterial concentration reached 10⁸ cells/mL, the activation culture was completed and a resulting filter residue was removed.
(3) A resulting activation cultured Acidithiobacillus ferrooxidans was inoculated into 6 L of 9K culture medium containing 9 g/L of ferrous iron with 10% inoculation volume and subjected to scale-up culture, with an initial pH value being 2, a temperature being 30° C., and a shaker speed being 170 r/min. Number of living cells was counted by blood cell counting plate every day. When a culture concentration could reach 10⁸ cells/mL, the scale-up culture was completed and a resulting filter residue was removed to obtain a concentrated culture.
(4) The concentrated culture was inoculated into 150 mL of passivation solution consisting of 44.7 g/L of FeSO₄.7H₂O and 9K culture medium with 30 mM K⁺ concentration, and a bacterial concentration in the passivation solution was 1×10⁸ cells/mL. An initial pH of the passivation solution was adjusted to 2 by dropping sulfuric acid, and a resulting treated passivation solution was injected into a stirred reactor filled with 1.5 g of sample, after which the sample was passivated for 138 h under conditions of a solid-liquid ratio of 1%, a shaker speed of 170 r/min and a temperature of 25° C., 30° C., 35° C., 40° C., and 45° C., respectively.

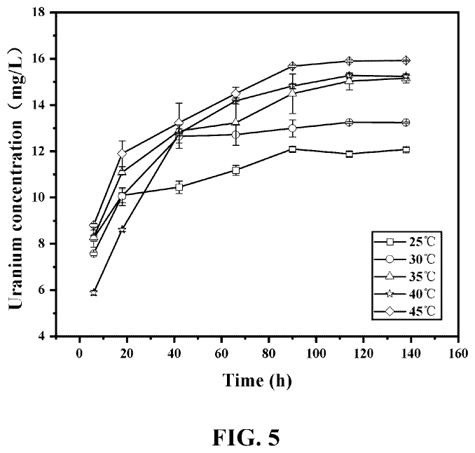

FIG. 5 shows a graph of leached uranium concentration after biological passivation for 138 h under different temperatures. The results show that when the temperature is 30° C., the passivation of slag reaches a stable point more quickly, and there is no leaching in the following time, whereas all other groups show an upward trend. It shows that the method of the present disclosure can quickly coat the slag and prevent the radioactive metal from being continuously leached, which is of great significance to the environmental management and protection of the mining area.

### Example 4

(1) Heap leaching uranium tailings residue was crushed and sieved to obtain a sample with a particle size of 0.074 mm.
(2) A bacterial cell suspension of Acidithiobacillus ferrooxidans was inoculated into 100 mL of 9K culture medium with 10% inoculation volume and subjected to activation culture, with an initial pH value being 2.0, a temperature being 30° C., and a shaker speed being 170 r/min. Number of living cells was counted by blood cell counting plate every day. When a bacterial concentration reached 10⁸ cells/mL, the activation culture was completed and a resulting filter residue was removed.
(3) A resulting activation cultured Acidithiobacillus ferrooxidans was inoculated into 6 L of 9K culture medium containing 9 g/L of ferrous iron with 10% inoculation volume and subjected to scale-up culture, with an initial pH value being 2, a temperature being 30° C., and a shaker speed being 170 r/min. Number of living cells was counted by blood cell counting plate every day. When a culture concentration could reach 10⁸ cells/mL, the scale-up culture was completed and a resulting filter residue was removed to obtain a concentrated culture.
(4) The concentrated culture was inoculated into 150 mL of passivation solution consisting of 44.7 g/L of FeSO₄.7H₂O and 9K culture medium with 30 mM K⁺ concentration, and a bacterial concentration in the passivation solution was 1×10⁸ cells/mL. An initial pH of the passivation solution was adjusted to 2 by dropping sulfuric acid, and a resulting treated passivation solution was injected into a stirred reactor filled with 1.5 g of sample, after which the sample was passivated for 138 h under conditions of a solid-liquid ratio of 1%, 5%, 10%, and 15%, respectively, a shaker speed of 170 r/min, and a temperature of 30° C.

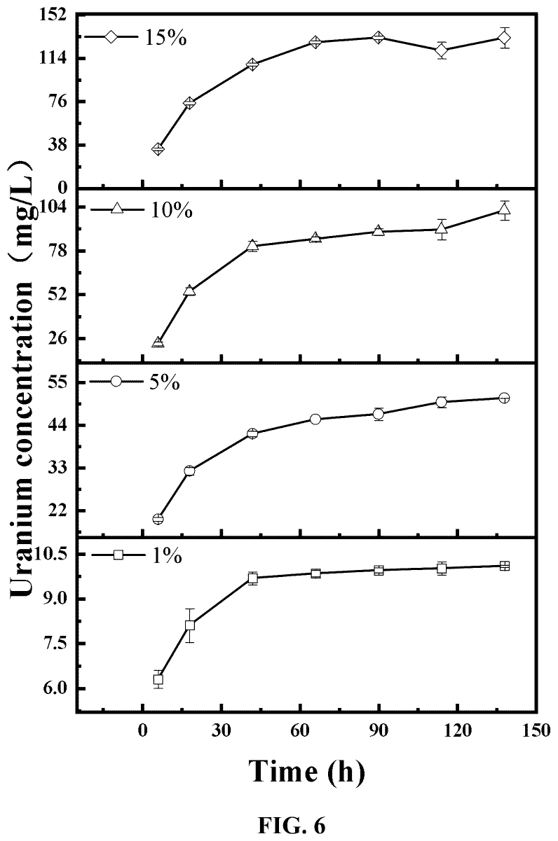

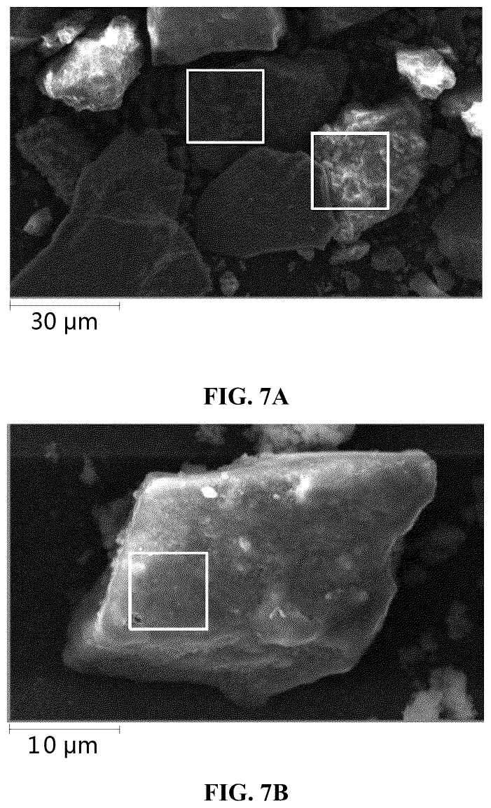

FIG. 6 shows a graph of leached uranium concentration after biological passivation for 138 h under different solid-liquid ratios (ratio of powder sample to passivation solution). The results show that when the solid-liquid ratio is in a range of 1% to 5%, uranium is partially leached from the tailings residue (the leaching solution is recovered by ion exchange resin), but it reaches a stable point more quickly, and there is no leaching in the following time, whereas all other groups show an upward trend. It shows that the method of the present disclosure can quickly coat the slag and prevent the radioactive metal from being continuously leached, which is of great significance to the environmental management and protection of the mining area.

### Comparative Example 1

(1) Heap leaching uranium tailings residue was crushed and sieved to obtain a sample with a particle size of 0.074 mm.
(2) A bacterial cell suspension of Acidithiobacillus ferrooxidans was inoculated into 100 mL of 9K culture medium with 10% inoculation volume and subjected to activation culture, with an initial pH value being 2.0, a temperature being 30° C., and a shaker speed being 170 r/min. Number of living cells was counted by blood cell counting plate every day. When a bacterial concentration reached 10⁸ cells/mL, the activation culture was completed and a resulting filter residue was removed.
(3) A resulting activation cultured Acidithiobacillus ferrooxidans was inoculated into 6 L of 9K culture medium containing 9 g/L of ferrous iron with 10% inoculation volume and subjected to scale-up culture, with an initial pH value being 2, a temperature being 30° C., and a shaker speed being 170 r/min. When a culture concentration could reach 10⁸ cells/mL, the scale-up culture was completed and a resulting filter residue was removed to obtain a concentrated culture.
(4) The concentrated culture was added into 150 mL of deionized water, and a bacterial concentration in the passivation solution was 1×10⁸ cells/mL. An initial pH of the solution was adjusted to 2 by dropping sulfuric acid, and a resulting treated solution was injected into a stirred reactor filled with 1.5 g of sample, after which the sample was passivated for 138 h under conditions of a solid-liquid ratio of 1%, a shaker speed of 170 r/min, and a temperature of 30° C.

FIG. 7A shows the scanning electron microscope image of the raw sample in Comparative Example 1 (sample with a particle size of less than 0.074 mm), and FIG. 7B shows the scanning electron microscope image of the sample in Example 1 after passivation for 138 h. As shown in FIGS. 7A to 7B, it can be seen that there are obvious corrosion pits on the surface of slag which is not biologically passivated without adding iron source, while there are no obvious corrosion pits, and a “protective layer” is formed on the surface of the slag which is biologically passivated with adding iron source.

The passivated samples obtained in Example 1 and Comparative Example 1 were dried and placed into 100 mL of natural water and acidic water with pH 2 (prepared by adding sulfuric acid to deionized water), respectively. The natural water acidification and leaching resistance experiments were performed under the conditions of a shaker speed of 170 r/min and a temperature of 30° C.

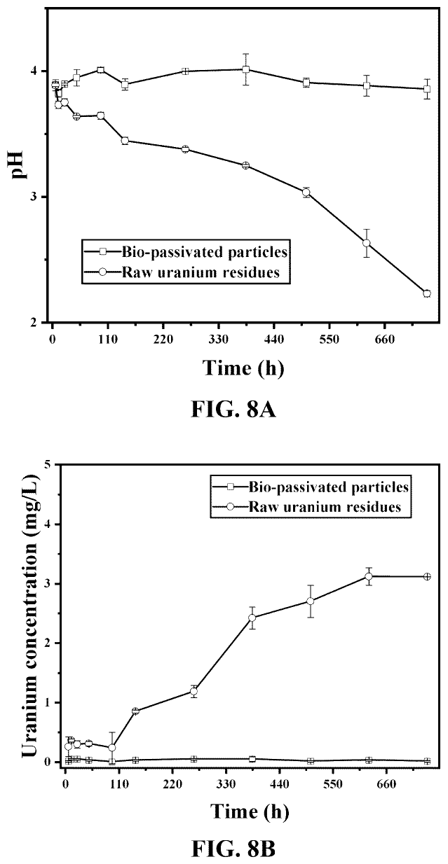

The results are shown in FIGS. 8A to 8B, where FIG. 8A shows the pH change graph of Example 1 (sample with a particle size of less than 0.074 mm) and Comparative Example 1, and FIG. 8B shows the leached uranium graph of Example 1 (sample with a particle size of less than 0.074 mm) and Comparative Example 1.

As can be seen from FIG. 8A, the pH value of the passivated slag in Example 1 changes stably, maintaining at about 4, while the pH value of the slag which is not passivated in Comparative Example 1 continues to drop to about 2.3. As can be seen from FIG. 8B, after 30 days of leaching resistance experiment, the maximum leaching amount of uranium from the passivated slag in Example 1 does not exceed 0.035 mg/L, whereas the leaching amount of uranium from the slag which is not passivated in Comparative Example 1 is 3 mg/L, which is nearly 100 times that of Example 1.

The above results show that the method provided by the present disclosure can form a mineral film on the surface of uranium-containing waste (the components of the mineral film include one or more of jarosite, goethite, magnetite, gypsum, diaspore or kaolinite), which effectively inhibit the migration and release of radioactive metal element uranium and the acidification phenomenon in uranium-containing waste and reduce the risk of uranium release from the source.

Although the embodiments described above have provided a detailed description of the present disclosure, they are only some, rather than all, of the embodiments of the present disclosure. All other embodiments that can be obtained according to the embodiments of the present disclosure without involving any inventive effort shall fall within the scope of the present disclosure.

What is claimed is:

1. A method for stabilizing and immobilizing uranium at source via formation of a mineral film mediated by microorganisms, comprising the following step:
forming the mineral film on a surface of a uranium-containing waste through mediation by acidophilic iron-oxidizing microorganisms using an additional ferrous source.

2. The method of claim 1, wherein the acidophilic iron-oxidizing microorganisms are at least one selected from the group consisting of Acidithiobacillus ferrooxidans, Leptospirillum ferriphilum, Leptospirillum ferrooxidans, and Sulfobacillus thermosulfidooxidans.

3. The method of claim 1, wherein the uranium-containing waste comprises at least one selected from the group consisting of a uranium tailings residue, a uranium tailings sand, and a uranium-containing waste stone.

4. The method of claim 1, wherein the additional ferrous source is at least one selected from the group consisting of ferrous sulfate and a pyrite.

5. The method of claim 1, wherein forming the mineral film on the surface of the uranium-containing waste through the mediation by the acidophilic iron-oxidizing microorganisms using the additional ferrous source comprises:
crushing and sieving the uranium-containing waste to obtain uranium-containing particles or powders;
inoculating a bacterial cell suspension of the acidophilic iron-oxidizing microorganisms into a ferrous-containing culture medium and culturing, to obtain a culture;
inoculating the culture into the additional ferrous source to obtain a passivation solution; and
passivating the uranium-containing particles or powders by using the passivation solution to form the mineral film on the surface of the uranium-containing waste particles or powders.

6. The method of claim 5, wherein the uranium-containing particles or powders each have a particle size of not greater than 5 mm.

7. The method of claim 5, wherein the passivating is conducted in a stirred reactor or a column percolation reactor; and
the passivation solution has an initial pH value of 1.5 to 6, and the passivating is conducted at a temperature of 25° C. to 45° C.

8. The method of claim 7, wherein under a condition that the passivating is conducted in the stirred reactor, a solid-liquid ratio for the passivating is less than 15% and the passivating is conducted for not less than 6 hours; and
under a condition that the passivating is conducted in the column percolation reactor, the solid-liquid ratio for the passivating is less than 3:1 and the passivating is conducted for not less than 10 days.

9. The method of claim 5, wherein the passivation solution further comprises an additional cation;
the additional cation is at least one selected from the group consisting of potassium ions, sodium ions, and ammonium ions; and
an ionic molar ratio of the additional ferrous source to the additional cation is in a range of 3:0.5 to 3:2.

10. A passivation solution, comprising acidophilic iron-oxidizing microorganisms and an additional ferrous source.

11. The method of claim 2, wherein the uranium-containing waste comprises at least one selected from the group consisting of a uranium tailings residue, a uranium tailings sand, and a uranium-containing waste stone.

12. The method of claim 2, wherein the additional ferrous source is at least one selected from the group consisting of ferrous sulfate and a pyrite.

13. The method of claim 6, wherein the passivation solution further comprises an additional cation;
the additional cation is at least one selected from the group consisting of potassium ions, sodium ions, and ammonium ions; and
an ionic molar ratio of the additional ferrous source to the additional cation is in a range of 3:0.5 to 3:2.

14. The method of claim 7, wherein the passivation solution further comprises an additional cation;
the additional cation is at least one selected from the group consisting of potassium ions, sodium ions, and ammonium ions; and
an ionic molar ratio of the additional ferrous source to the additional cation is in a range of 3:0.5 to 3:2.

15. The method of claim 8, wherein the passivation solution further comprises an additional cation;
the additional cation is at least one selected from the group consisting of potassium ions, sodium ions, and ammonium ions; and
an ionic molar ratio of the additional ferrous source to the additional cation is in a range of 3:0.5 to 3:2.
